(19) United States
(12) Patent Application Publication
(10) Pub. No.: US 2021/0244255 A1
(43) Pub. Date: Aug. 12, 2021

(54) DISHWASHER

(71) Applicant: ELECTROLUX APPLIANCES AKTIEBOLAG, Stockholm (SE)

(72) Inventors: Anders HAEGERMARCK, Trångsund (SE); Eduardo MARTINEZ, Stockholm (SE)

(21) Appl. No.: 16/972,801

(22) PCT Filed: Jun. 8, 2018
(86) PCT No.: PCT/EP2018/065200

§ 371 Date: Dec. 7, 2020

(51) Int. Cl. A47L 15/42

(52) U.S. Cl. CPC A47L 15/4217; A47L 15/4291; A47L 2501/01; A47L 2401/14; A47L 2401/08

(57) ABSTRACT

A dishwasher may include a washing chamber including a sump. The dishwasher may further include a water inlet tank configured to accommodate water for use in a wash cycle in the washing chamber, a water inlet conduit configured to supply water to the water inlet tank, and a drain pump including an inlet and an outlet, wherein the inlet is fluidly connected to the sump. The dishwasher may include a drain conduit fluidly connected to the outlet of the drain pump and a heat exchanger configured to exchange heat between the drain conduit and the water inlet conduit.

### TECHNICAL FIELD

The present disclosure relates to a dishwasher.

### BACKGROUND

A dishwasher is an apparatus for washing items such as dishware and cutlery. A dishwasher comprises a washing chamber where the items are positioned, usually in racks, and dishwashers typically comprise one or more spray arms spraying washing liquid, e.g. a mixture of water and detergent, onto the items to clean them. The washing liquid is collected in a sump at a bottom of the washing chamber. A circulation pump of the dishwasher is fluidly connected to the sump and pumps washing liquid from the sump to the spray arms during a wash cycle. In order to improve the cleaning efficiency and the final cleaning result, the washing liquid is heated to a high temperature, typically between 45 and 75° C., by one or more heating elements of the dishwasher.

There are many requirements on today's dishwashers. Examples of such requirements are that a dishwasher is expected to wash items with a good cleaning result while environmental concerns require an efficient use of energy during a washing session. Furthermore, generally, on today's consumer market, it is an advantage if products, such as dishwashers, have conditions and/or characteristics suitable for being manufactured and assembled in a cost-efficient manner.

Attempts have been made to reduce the energy consumption of dishwashers by introducing heat recovery systems, heat pumps, and the like. However, many of these systems and arrangements are complex, expensive, require a lot of space in the dishwasher, and cause an increased risk of clogging of pipes and conduits of the dishwasher.

### SUMMARY

It is an object of the present invention to overcome, or at least alleviate, at least some of the above-mentioned problems and drawbacks.

According to a first aspect of the invention, the object is achieved by a dishwasher comprising a washing chamber comprising a sump. The dishwasher further comprises a water inlet tank configured to accommodate water for use in a wash cycle in the washing chamber, a water inlet conduit configured to supply water to the water inlet tank, and a drain pump comprising an inlet and an outlet, wherein the inlet is fluidly connected to the sump.

The dishwasher further comprises a drain conduit fluidly connected to the outlet of the drain pump, and a heat exchanger configured to exchange heat between the drain conduit and the water inlet conduit.

Since the dishwasher comprises a heat exchanger configured to exchange heat between the drain conduit and the water inlet conduit, a dishwasher is provided capable of transferring heat from liquid in the drain conduit to water in the water inlet conduit in a simple and efficient manner. Thereby, the energy required for heating the water in a subsequent wash cycle is substantially reduced. As a result, the inputted energy used during a washing session of the dishwasher is reduced.

Moreover, a dishwasher is provided capable of transferring heat from liquid in the drain conduit to water in the water inlet conduit without the use of a complicated system, and in a manner allowing the use of a simple low-cost water inlet tank, as compared to dishwashers with other types of heat recovery systems. As a result, a dishwasher is provided having conditions and characteristics suitable for being manufactured and assembled in a cost-efficient manner.

Furthermore, since the water inlet tank and the heat exchanger are separate units, the available space in the dishwasher can be utilized in an efficient manner. Moreover, since the water inlet tank and the heat exchanger are separate units and the water inlet tank is configured to accommodate water for use in a wash cycle, a flexible dishwasher is provided having conditions for filling the water inlet tank, and transferring heat to water flowing through the water inlet conduit, when wanted. As a further result thereof, the energy efficiency of the dishwasher can be further improved.

Accordingly, a dishwasher is provided overcoming, or at least alleviating, at least some of the above-mentioned problems and drawbacks. As a result, the above-mentioned object is achieved.

Optionally, the dishwasher further comprises a valve configured to control flow of water in the water inlet conduit, and a control arrangement configured to selectively control an opening state of the valve based on an operational state of the drain pump. Thereby, the energy efficiency of the dishwasher can be further improved due to improved heat transfer from liquid in the drain conduit to water in the water inlet conduit.

Optionally, the control arrangement is configured to estimate a flow rate of liquid flowing through the drain conduit, and wherein the control arrangement is configured to control the opening state of the valve based on the estimated flow rate of liquid flowing through the drain conduit. Thereby, the energy efficiency of the dishwasher can be further improved by improving the heat transfer from liquid in the drain conduit to water in the water inlet conduit.

Optionally, the control arrangement is configured to estimate the flow rate of liquid flowing through the drain conduit by monitoring the torque of the drain pump. Thereby, the flow rate of liquid flowing through the drain conduit is estimated in a simple and efficient manner without the need for additional sensors. Thus, a dishwasher is provided having conditions and characteristics suitable for being manufactured and assembled in a cost-efficient manner.

Optionally, the control arrangement is configured to open the valve when it is estimated that liquid is flowing through the drain conduit, and/or when it is estimated that liquid recently has flowed through the drain conduit. Thereby, the energy efficiency of the dishwasher is further improved because the heat transfer from liquid in the drain conduit to water in the water inlet conduit is further improved.

Optionally, the control arrangement is further configured to control the drain pump. Thereby, a still more flexible dishwasher is provided, with improved controllability, thus providing conditions for a further improved energy efficiency of the dishwasher by improving the heat transfer from liquid in the drain conduit to water in the water inlet conduit.

Optionally, the control arrangement is configured to control the drain pump to operate in cycles. Thereby, the energy efficiency of the dishwasher is further improved because more time is available for heat transfer from liquid in the drain conduit to water in the water inlet conduit. Furthermore, the pulsating flow of the liquid in the drain conduit may contribute to a turbulent flow in the second passage of the heat exchanger which increases heat transfer to water in the first passage of the heat exchanger.

Optionally, the cycles comprise operation intervals and standstill intervals between the operation intervals. Thereby, the energy efficiency of the dishwasher is further improved because more time is available during the standstill intervals for heat transfer from liquid in the drain conduit to water in the water inlet conduit. Furthermore, the pulsating flow of the liquid in the drain conduit may contribute to a turbulent flow in the second passage of the heat exchanger which increases heat transfer to water in the first passage of the heat exchanger.

Optionally, a length of the standstill intervals is within the range of 0.5 seconds to 7 seconds, such as within the range of 1 second to 3 seconds. Thereby, an improved energy efficiency is provided while the time required for drainage is not significantly increased.

Optionally, a length of the operation intervals is within the range of 0.5 seconds to 3 seconds, such as within the range of 0.7 seconds to 1.5 seconds. Thereby, an improved energy efficiency is provided while the time required for drainage is not significantly increased.

Optionally, the heat exchanger comprises a first passage configured to conduct water flowing through the water inlet conduit and a second passage configured to conduct liquid flowing through the drain conduit. Thereby, a simple and efficient heat exchanger is provided.

Optionally, the heat exchanger comprises a wall separating the first and second passages, wherein the wall is corrugated. Thereby, the heat transfer from liquid in the drain conduit to water in the water inlet conduit is further improved. This because the corrugated wall increases the surface area between the first and second passages and because the corrugated wall may contribute to a turbulent flow of liquid through the first and second passages. In this manner, the energy efficiency of the dishwasher is further improved.

Optionally, the heat exchanger comprises a vortex generator at an inlet of the second passage. Thereby, the heat transfer from liquid in the drain conduit to water in the water inlet conduit is further improved. This because the vortex generator will generate a vortex in the liquid flowing into the second passage of the heat exchanger, which creates a more turbulent flow through the second passage. In this manner, the energy efficiency of the dishwasher is further improved.

Optionally, the first passage is arranged to conduct water in a first flow direction and the second passage is arranged to conduct liquid in a second flow direction, and wherein the second flow direction is opposite to the first flow direction. Thereby, the energy efficiency of the dishwasher is further improved because the heat transfer from liquid in the drain conduit to water in the water inlet conduit is further improved.

Optionally, the first and second passages are coaxially arranged. Thereby, a simple and efficient heat exchanger is provided having conditions and characteristics suitable for being manufactured and assembled in a cost-efficient manner. Furthermore, a heat exchanger is provided requiring little space in the dishwasher. In this manner, the heat exchanger will have a low impact on the space available for other components of the dishwasher, such as the washing chamber of the dishwasher.

Optionally, the first passage is coaxially arranged around the second passage. Thereby, heat can be transferred from liquid in the drain conduit to water in the water inlet conduit in an efficient manner, while the risk for clogging in the second passage is kept low, for example with particles in the drain liquid.

Optionally, the heat exchanger is arranged at a bottom of the dishwasher. Thereby, the available space in the dishwasher is utilized in an efficient manner. Moreover, a short distance is provided between the drain pump and the heat exchanger. In this manner, a short conduit can be arranged between the outlet of the drain pump and the inlet of the second passage, which reduces heat loss of liquid flowing from the drain pump to the heat exchanger, thus ensuring an efficient heat transfer in the heat exchanger. As a further result thereof, conditions are provided for an efficient utilization of energy in the dishwasher.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 schematically illustrates a dishwasher according to some embodiments.

### DETAILED DESCRIPTION

Aspects of the present invention will now be described more fully. Like numbers refer to like elements throughout. Well-known functions or constructions will not necessarily be described in detail for brevity and/or clarity.

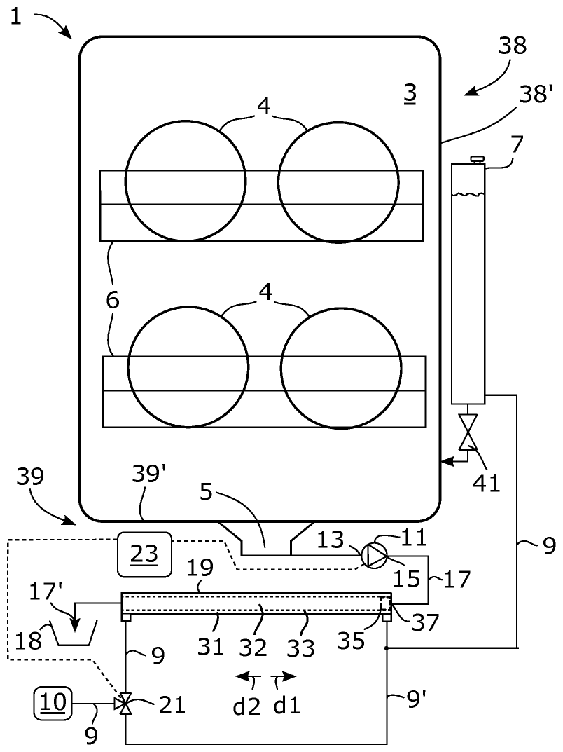

FIG. 1 schematically illustrates a dishwasher 1, according to some embodiments. The dishwasher 1 comprises a washing chamber 3 configured to accommodate items 4 to be washed in the washing chamber 3. According to the illustrated embodiments, the dishwasher 1 comprises racks 6 configured to hold the items 4 in the washing chamber 3. The dishwasher 1 further comprises a sump 5 at a bottom 39 of the dishwasher 1. Moreover, the dishwasher 1 comprises a door arranged to provide a closure to the washing chamber 3, one or more spray devices, such as spray arms, and a circulation pump. The circulation pump is configured to pump liquid from the sump 5 to the spray devices during a wash cycle of the dishwasher 1. The liquid is sprayed from the spray devices onto the items 4 to clean the items 4. Due to gravity, the liquid is collected in the sump 5 where it is pumped again by the circulation pump to the spray devices. For the reason of brevity and clarity, the door, the spray devices, and the circulation pump are not illustrated in FIG. 1.

The dishwasher 1 comprises a water inlet tank 7 configured to accommodate water for use in a wash cycle in the washing chamber 3. The dishwasher 1 further comprises a water inlet conduit 9 configured to supply water to the water inlet tank 7. According to the illustrated embodiments, the water inlet conduit 9 is connected to a water supply network 10. Furthermore, the dishwasher 1 comprises a drain pump 11 comprising an inlet 13 and an outlet 15. The inlet 13 of the drain pump 11 is fluidly connected to the sump 5. The dishwasher 1 further comprises a drain conduit 17 fluidly connected to the outlet 15 of the drain pump 11. An outlet 17′ of the drain conduit 17 is connected to a drain 18. The drain pump 11 is thus configured to pump liquid from the sump 5, through the drain conduit 17, to the drain 18. As is further explained herein, the drain pump 11 may comprise a pump unit and an electric motor configured to power the pump unit. The pump unit and the electric motor are not illustrated in FIG. 1 for the reason of brevity and clarity. The dishwasher 1 further comprises a heat exchanger 19. The heat exchanger 19 is configured to exchange heat between the drain conduit 17 and the water inlet conduit 9. In this manner, heat of liquid in the drain conduit 17 can be transferred to water in the water inlet conduit 9 in a simple and efficient manner, to thereby improve the energy efficiency of the dishwasher 1.

Furthermore, as can be seen in FIG. 1, according to the present disclosure, the heat exchanger 19 and the water inlet tank 7 are separate units. This provides several advantages, as is further explained herein. According to the illustrated embodiments, the water inlet tank 7 is arranged on a back 38 of the dishwasher 1, i.e. adjacent to a vertical wall 38′ of the washing chamber 3. The heat exchanger 19 is arranged at the bottom 39 of the dishwasher 1, i.e. below a bottom wall 39′ of the washing chamber 3. A volume of the water inlet tank 7 may for example be within the range of 2-6 litres, such as within the range of 3.2-4 litres.

According to the illustrated embodiments, the heat exchanger 19 comprises a first passage 31 configured to conduct water flowing through the water inlet conduit 9 and a second passage 32 configured to conduct liquid flowing through the drain conduit 17. Thus, according to the illustrated embodiments, the first passage 31 can be said to form a portion of the water inlet conduit 9 and the second passage 32 can be said to form a portion of the drain conduit 17. Furthermore, according to the illustrated embodiments, the water inlet conduit 9 comprises a bypass conduit 9′, bypassing the first passage 31. Moreover, the dishwasher 1 comprises a valve 21 configured to control flow of water in the water inlet conduit 9. According to the illustrated embodiments, the valve 21 is a three-way valve fluidly connected to the water supply network 10, to the water inlet conduit 9 and to the bypass conduit 9′. The valve 21 is controllable between a closed position and a first and a second open position. In the closed position, the valve 21 closes a fluid connection between the water supply network 10 and the water inlet conduit 9 and the bypass conduit 9′. In the first open position, a fluid connection is open between the water supply network 10 and the water inlet conduit 9 and a fluid connection is closed between the water supply network 10 and the bypass conduit 9′. In the second open position, the fluid connection is open between the water supply network 10 and the bypass conduit 9′. Moreover, in the second open position, a fluid connection between the water supply network 10 and the first passage 31 of the heat exchanger 19 may be closed.

The dishwasher 1 further comprises a control arrangement 23 configured to selectively control the opening state of the valve 21 based on an operational state of the drain pump 11. For example, at the end of a wash cycle, when the sump 5 is to be emptied, and the drain pump 11 is operating, the control arrangement 2 may control the valve 21 to the first open position such that water flows from the water supply network 10 towards the water inlet tank 7 via the water inlet conduit 9. In this manner, heat of the liquid in the drain conduit 17 is transferred to water in the water inlet conduit 9 and the heat can be utilized in a subsequent wash cycle in the washing chamber 3. At other occasions, when no heat is wanted in the incoming water to the water inlet tank 7, the control arrangement 23 may control the opening state of the valve 21 to the second opening state. In this manner, the cold water from the water supply network 10 is flowing through the bypass line 9′ to the water inlet tank 7, i.e. past the heat exchanger 19. Occasions when no heat is wanted in the incoming water to the water inlet tank 7 may for example comprise a rinse cycle, a quick cycle, a softener regeneration cycle, a drying cycle, or the like.

The control arrangement 23 may be configured to estimate a flow rate of liquid flowing through the drain conduit 17 and control the opening state of the valve 21 based on the estimated flow rate of liquid flowing through the drain conduit 17. In this manner, the heat transfer from liquid in the drain conduit 17 to water in the water inlet conduit 9 can be further optimized. The control arrangement 23 may be configured to estimate the flow rate of liquid flowing through the drain conduit 17 by monitoring the torque of the drain pump 11. Thereby, the flow rate of liquid flowing through the drain conduit 17 is estimated in a simple and efficient manner without the need for additional sensors. The control arrangement 23 may monitor the torque of the drain pump 11 by monitoring electrical quantities, such as current and voltage, of an electric motor of the drain pump 11. The flow rate of liquid flowing through the drain conduit 17 significantly affects the torque of the drain pump and the electrical quantities of the electric motor of the drain pump 11. For example, if the flow rate of liquid flowing through the drain conduit 17 is high, the torque of the drain pump 11 is high. Contrarywise, if the flow rate of liquid flowing through the drain conduit 17 is low, and/or if the drain pump 11 is sucking air, the torque of the drain pump 11 is low.

According to the illustrated embodiments, the control arrangement 23 is configured to open the valve 21 such that water is flowing through the inlet water conduit 9, i.e. control the valve 21 to the first open position, when it is estimated that liquid is flowing through the drain conduit 17, and/or when it is estimated that liquid recently has flowed through the drain conduit 17. In this manner, the heat transfer from liquid in the drain conduit 17 to water in the water inlet conduit 9 is further optimized. Moreover, according to the illustrated embodiments, the control arrangement 23 is further configured to control the drain pump 11. That is, according to the illustrated embodiments, the control arrangement 23 is configured to perform a simultaneous control of the opening state of the valve 21 and the operation of the drain pump 11. In this manner, the heat transfer from liquid in the drain conduit 17 to water in the water inlet conduit 9 can be further optimized. The dishwasher 1 may comprise a flow meter at the water inlet conduit 9. According to such embodiments, the control arrangement 23 may control the opening state of the valve 21 so as to obtain a wanted flowrate of water through the water inlet conduit 9, and/or so as to obtain a wanted fill level of the water inlet tank 7, using data of the flow meter.

In addition, according to embodiments of the present disclosure, the control arrangement 23 is configured to control the drain pump 11 to operate in cycles during an emptying process of the sump 5. The cycles may comprise operation intervals and standstill intervals between the operation intervals. Due to these features, the energy efficiency of the dishwasher 1 is further improved because more time is available for heat transfer from liquid in the drain conduit 17 to water in the water inlet conduit 9. In addition, the pulsation of the liquid in the drain conduit 17 may contribute to a turbulent flow in the second passage 32 of the heat exchanger 19 which increases heat transfer to water in the first passage 31 of the heat exchanger 19. A length of the standstill intervals is within the range of 0.5 seconds to 7 seconds, such as within the range of 1 second to 3 seconds. A length of the operation intervals is within the range of 0.5 seconds to 3 seconds, such as within the range of 0.7 seconds to 1.5 seconds. According to the illustrated embodiments, the heat exchanger 19 comprises a wall 33 separating the first and second passages 31, 32. According to some embodiments, the wall 33 is corrugated. Thereby, the heat transfer from liquid in the drain conduit 17 to water in the water inlet conduit 9 is further improved. Furthermore, according to the illustrated embodiments, the heat exchanger 19 comprises a vortex generator 35 at an inlet 37 of the second passage 32. As a result, the heat transfer from liquid in the drain conduit 17 to water in the water inlet conduit 9 is further improved because the vortex generator 35 generates a vortex in the liquid flowing into the second passage 32 which may last through a significant portion of the second passage 32. The vortex generator 35 may comprise one or more blades extending into the second passage 32. The wall 33 separating the first and second passages 31, 32, as well as other delimiting walls of the first and second passages 31, 32, may be formed by stainless steel. The thickness of the wall 33 separating the first and second passages 31, 32 may for example be within the range of 0.7-3.5 mm, such as within the range of 1-2 mm. The length of the heat exchanger 19, i.e. the length of the respective first and second passages 31, 32 in the respective flow direction thereof, may be within the range of 1-3 meters, such as within the range of 1.5-2 meters. The heat exchanger 19 may not be straight, as is the case according to the schematic illustration of FIG. 1, but may be curved, for example around the sump 5. The diameter of the second passage 32 of the heat exchanger 19 may be within the range of 10-21 mm, such as within the range of 14-18 mm. The outer diameter of the heat exchanger 19 may be within the range of 23-40 mm, such as within the range of 25-35 mm.

Furthermore, according to the illustrated embodiments, the first passage 31 is arranged to conduct water in a first flow direction d1 and the second passage 32 is arranged to conduct liquid in a second flow direction d2, and wherein the second flow direction d2 is opposite to the first flow direction d1. Thereby, the energy efficiency of the dishwasher 1 is further improved because the heat transfer from liquid in the drain conduit 17 to water in the water inlet conduit 9 is further improved. Moreover, the first and second passages 31, 32 are coaxially arranged, wherein the first passage 31 is coaxially arranged around the second passage 32. Thereby, heat can be transferred from liquid in the drain conduit 17 to water in the water inlet conduit 9 in an efficient manner, while the risk for clogging in the second passage 32 is kept low, for example with particles in the drain liquid in the second passage 32. Furthermore, due to these features, a compact heat exchanger 19 is provided. As a result, the heat exchanger 19 has a low impact on the space available for other components of the dishwasher 1, such as the washing chamber 3 of the dishwasher 1.

According to the illustrated embodiments, the heat exchanger 19 is arranged at the bottom 39 of the dishwasher 1. In that way, the space available in the dishwasher is utilized in an efficient manner. Moreover, a short distance is provided between the outlet 15 of the drain pump 11 and the inlet 37 of the second passage 32 of the heat exchanger 19. In this manner, a short conduit can be arranged between the outlet 15 of the drain pump 11 and the inlet 37 of the second passage 32, which reduces heat loss of liquid flowing from the drain pump 11 to the heat exchanger 19, which ensures an efficient heat transfer in the heat exchanger 19.

The control arrangement 23 may be connected to further components of the dishwasher 1 than depicted in FIG. 1. Examples of such components are a circulation pump, a valve 41 arranged to control flow of water from the water inlet tank 7 to the washing chamber 3, a sensor arranged to detect an opening state of a door of the dishwasher, a user interface of the dishwasher, one or more flow sensors, and/or one or more pressure sensors.

The control arrangement 23 may comprise a calculation unit which may take the form of substantially any suitable type of processor circuit or microcomputer, e.g. a circuit for digital signal processing (digital signal processor, DSP), a Central Processing Unit (CPU), a processing unit, a processing circuit, a processor, a microprocessor, or other processing logic that may interpret and execute instructions. The herein utilised expression “calculation unit” may represent a processing circuitry comprising a plurality of processing circuits, such as, e.g., any, some or all of the ones mentioned above.

The control arrangement 23 may further comprise a memory unit, wherein the calculation unit may be connected to the memory unit, which may provide the calculation unit with, for example, stored program code and/or stored data which the calculation unit may need to enable it to do calculations. The calculation unit may also be adapted to store partial or final results of calculations in the memory unit. The memory unit may comprise a physical device utilised to store data or programs, i.e., sequences of instructions, on a temporary or permanent basis. According to some embodiments, the memory unit may comprise integrated circuits comprising silicon-based transistors. The memory unit may comprise e.g. a memory card, a flash memory, or another similar volatile or non-volatile storage unit for storing data.

The control arrangement 23 is connected to components of the dishwasher 1 for receiving and/or sending input and output signals. These input and output signals may comprise waveforms, pulses or other attributes which the input signal receiving devices can detect as information and which can be converted to signals processable by the control arrangement 23. These signals may then be supplied to the calculation unit.

In the embodiments illustrated, the dishwasher 1 comprises a control arrangement 23 but might alternatively be implemented wholly or partly in two or more control arrangements or two or more control units.

It is to be understood that the foregoing is illustrative of various example embodiments and that the invention is defined only by the appended claims. A person skilled in the art will realize that the example embodiments may be modified, and that different features of the example embodiments may be combined to create embodiments other than those described herein, without departing from the scope of the present invention, as defined by the appended claims.

As used herein, the term “comprising” or “comprises” is open-ended, and includes one or more stated features, elements, steps, components or functions but does not preclude the presence or addition of one or more other features, elements, steps, components, functions or groups thereof.

1. A dishwasher comprising:
a washing chamber comprising a sump,
a water inlet tank configured to accommodate water for use in a wash cycle in the washing chamber,
a water inlet conduit configured to supply water to the water inlet tank,
a drain pump comprising an inlet and an outlet, wherein the inlet is fluidly connected to the sump,
a drain conduit fluidly connected to the outlet of the drain pump, and
a heat exchanger configured to exchange heat between the drain conduit and the water inlet conduit.

2. The dishwasher according to claim 1, wherein the dishwasher further comprises:
a valve configured to control flow of water in the water inlet conduit, and
a control arrangement configured to selectively control an opening state of the valve based on an operational state of the drain pump.

3. The dishwasher according to claim 2, wherein the control arrangement is configured to estimate a flow rate of liquid flowing through the drain conduit, and wherein the control arrangement is configured to control the opening state of the valve based on the estimated flow rate of liquid flowing through the drain conduit.

4. The dishwasher according to claim 3, wherein the control arrangement is configured to estimate the flow rate of liquid flowing through the drain conduit by monitoring the torque of the drain pump.

5. The dishwasher according to claim 3, wherein the control arrangement is configured to open the valve when it is estimated that liquid is flowing through the drain conduit, and/or when it is estimated that liquid recently has flowed through the drain conduit.

6. The dishwasher according to claim 2, wherein the control arrangement is further configured to control the drain pump.

7. The dishwasher according to claim 6, wherein the control arrangement is configured to control the drain pump to operate in cycles.

8. The dishwasher according to claim 7, wherein the cycles comprise operation intervals and standstill intervals between the operation intervals.

9. The dishwasher according to claim 8, wherein a length of the standstill intervals is within the range of 0.5 seconds to 7 seconds, such as within the range of 1 second to 3 seconds.

10. The dishwasher according to claim 8, wherein a length of the operation intervals is within the range of 0.5 seconds to 3 seconds, such as within the range of 0.7 seconds to 1.5 seconds.

11. The dishwasher according to claim 1, wherein the heat exchanger comprises a first passage configured to conduct water flowing through the water inlet conduit and a second passage configured to conduct liquid flowing through the drain conduit.

12. The dishwasher according to claim 11, wherein the heat exchanger comprises a wall separating the first and second passages, wherein the wall is corrugated.

13. The dishwasher according to claim 11, wherein the heat exchanger comprises a vortex generator at an inlet of the second passage.

14. The dishwasher according to claim 11, wherein the first passage is arranged to conduct water in a first flow direction and the second passage is arranged to conduct liquid in a second flow direction, and wherein the second flow direction is opposite to the first flow direction.

15. The dishwasher according to claim 1, wherein the first and second passages are coaxially arranged.

16. The dishwasher according to claim 15, wherein the first passage is coaxially arranged around the second passage.

17. The dishwasher according to claim 1, wherein the heat exchanger is arranged at a bottom of the dishwasher.
